(19) United States
(12) Patent Application Publication
(10) Pub. No.: US 2004/0125130 A1
(43) Pub. Date: Jul. 1, 2004

(54) Techniques for embedding custom user interface controls inside internet content

(76) Inventors: Andrea Flamini, Kansas City, MO (US); David Wilkins, Providence, RI (US); Matt Crosby, Vashon, WA (US); Randy Moss, Seattle, WA (US); Keith Fieldhouse, Seattle, WA (US)

Correspondence Address: James L Davison, Picture IQ Corporation, Suite 1601, 600 Stewart Street, Seattle, WA, 98101, US

(21) Appl. No.: 10/204,896

(22) PCT Filed: Feb. 26, 2001
(86) PCT No.: PCT/US01/06065

(51) Int. Cl. G09G 5/00

(52) U.S. Cl. 345/738

(57) ABSTRACT

The present invention describes a system and method for inserting custom user interface controls (65) such as a button or toolbar into a Web page (60). This allows the client device (20) rendering the Web page to use the controls to manipulate and transform data that resides on a remote server (120). In particular the controls may be used to manipulate and transform images that are viewed on the client device but actually reside on the remote server.

This application claims benefit of priority under 35 U.S.C. 119(e) of U.S. Provisional Application No. 60/185,324, filed Feb. 28, 2000 and entitled “Techniques For Embedding Custom User Interface Controls Inside Internet Content”.

### BACKGROUND

### FIELD

The present invention describes a lightweight system for inserting custom user interface (UI) controls (such as a button or image processing image processing toolbar) into a Web page to be rendered by a Web browser on a client computing device. This allows the client to interact with the custom UI controls to manipulate data stored on a remote server. The creation of the UI control and the processing of the commands that the UI control invokes on the remote data are handled by yet another server, a server that in one embodiment is independent of the Web server serving up the Web page.

This provides a mechanism for building a completely distributed environment in which the client interacts with a custom UI control that sends commands to a Imaging Server which processes the data independent of where the data resides (such as on the Application Server). Throughout this document, the following terms are used to describe the system. Client describes the client-computing device that runs the Web browser that enables the end user to directly interact with the system. The Application Server describes the system that serves up the Web pages to the client and stores the data (i.e. image files, data files, etc.). The Application Server can be thought of as two separate entities, a Web Server and a Data Server. The Imaging Server describes the server that creates UI controls that are displayed on the Client and, based on end user input, processes (or manipulates) data that resides on the Application Server.

The preferred embodiment does not require native extensions (plug-ins, ActiveX, etc.) to be added to the client nor Java code to be run on the client; nor does it require additional server side extensions on the Application Server. However, such extensions or use of Java code could further enhance this invention if they were desired to be added.

With this invention, it is possible to easily insert an editing component into a Web page without requiring additional modification to the Application Server for creation of this UI control. A Web page, as is well known in the art, contains a page description of data that is to be displayed in the Web browser. It contains data such as HTML, XML, or any language supported by the Web client-side browser. Further, the client can use this editing component to change the view or manipulate the contents of the data, but does not require additional support beyond basic Web page viewing capabilities and optional scripting capabilities (such as JavaScript, VBScript, Server Side Includes, Client Side Includes, etc.).

Using this invention, it is possible to get very similar, or identical results, on a variety of different clients, including those utilizing WebTV, browsers running in a variety of different operating system (such as Microsoft Windows, Macintosh OS, Linux, or other flavors of Unix), as well as future devices not yet available (such as AOL-TV or other Web-enabled embedded devices). This technique is expected to work on future, not yet released devices, since it is expected that any Web-enabled device that support Web browsing capabilities will minimally support standard Web viewing capabilities (such as HTML) and optional basic scripting capabilities (such as JavaScript) available and accepted as a standard today.

The real power of this invention is the encapsulation of the UI control from both the client browser and the Application Server. The creation of the UI control (such as the image processing toolbar) and the processing of user inputs of this UI control is handled solely by a separate Imaging Server, with no processing required by or changes to the Application Server that serves up the Web content. Further, the client browser is only required to support rendering of HTML pages and optional scripting support.

Another benefit is that this invention provides for multiple deployment strategies, depending on the specific customer's needs. In one embodiment, a set of central servers can handle many customers, thus simplifying the physical integration between the Imaging Server technology and the customer's Application Servers. The physical integration in this embodiment may be via a wide-area network connection. Although one set of central servers support many customers, each customer can still have their own custom UI controls (and look with their own appearance). In a separate embodiment, a “co-located ASP”¹ (Application Service Provider) approach is utilized. A co-located ASP model employs a system in which a third party installs and supports a separate server at a customers site and provides a particular application service. This provides minimal maintenance of the application by the customer since the service is installed and managed by a server owned and maintained by the third party. This co-location allows for high-bandwidth, low-latency network connectivity between the third party servers and the customer's servers via standard network protocols (such as HTTP). This allows the Imaging Server technology (running on separate servers) to still take advantage of physical locality to the customer's Application Servers, thus allowing use of higher-bandwidth, lower-latency network connectivity. The present invention allows each of these strategies to be utilized, without change to the underlying architecture.

Client side browser plug-ins were the first mechanism to extend a client's browsers. The benefit of this approach is that it is easy to extend the capabilities of the browser and provided for tight integrated between the plug-in and the client's browser to make it appear “as part of the browser.” Further, all processing occurs on the client's computer, with possible communication between the client and the Application Server as necessary.

It is possible to create a plug-ins that allow for viewing of previously unsupported media types (i.e. Apple QuickTime, Adobe Acrobat PDF, etc.). The main problem with this technique is that it is not only platform dependent, that is, code that is specific to and compiled for one platform such as Windows, Macintosh, Linux, Unix etc.), but also browser dependent (i.e. Microsoft Internet Explorer (IE) or Netscape Navigator). A different plug-in must be created and supplied to the client for the specific platform used and for the specific browser used. This is clearly a less than desirable solution, but for many years was the only solution. Furthermore, as new functionality is added to this plug-in, it must be re-downloaded and installed onto the client computing device (with possible re-launching of the browser, or worse, rebooting of the clients computer system.).

This solution does not work on devices in which a client-side browser plug-in cannot be easily created, such as Microsoft WebTV or a new class of Web-enabled embedded devices.

Java Applet

The use of Java code, and specifically Java applets, to extend the capabilities of the client's browsers is widely used. Java provides for a platform-independent mechanism for generating code that can be executed on any Java Virtual Machine (VM). In general, these are small and highly portable, provided the version of the Java code is compatible with the Java VM installed in the browser. Since Java code is interpreted by the VM (not complied into native code), there may be some performance issues, but modern Java runtime environments utilize other techniques (such as Just-in-time compliers) such that performance is not as much of an issue.

The biggest drawback with the use of Java is that this option only works on devices that support the Java run-time. For instance, Microsoft's WebTV currently does not have support for Java and thus Java is not a complete solution. It is also questionable if this solution will work on the new class of Web-enabled embedded devices since Java may not be supported on all devices.

Although Java may be supported in many environments (but not all), it does not imply that it is a stable environment. For example, the Linux implementation of the Java runtime is still not at the level of quality found in the Microsoft Windows version of Java.

There are other potential drawbacks with using Java code. These include the downloading of code to the client computer, the management of the code that is downloaded, and the execution of the code on the client.

ActiveX

Microsoft created ActiveX to allow for the easy migration of OLE/COM components to Web controls in the Microsoft Internet Explorer (IE) browser.

The main benefits of this approach is that existing code can be tightly integrated into IE and thus extend the capabilities greatly. This allows new functionality to be added to IE and executed on the client computing device.

The drawbacks include highly platform dependent, and browser dependent code that must be targeted at a variety of different platforms. Further, this option is not supported in Netscape Navigator on the Window's platform, thus a further restriction to the user base. Other problems include the requirement of new components that must be downloaded as they are modified. Finally, some operations may be better suited to be executed on a high-end server that can more readily perform computationally expensive imaging operations.

Not to be dismissed is the fact that ActiveX has some security issues involving the client computer. While there are authentication techniques employed by Microsoft, some customers may be reluctant to download many separate ActiveX extensions.

Kodak Picture Playground/CGI

The Kodak Picture Playground is a server-side imaging environment that provides basic image capabilities, without requiring the download of any components to the client computing device. With this approach, the imaging capabilities must be installed and fully integrated into the Application Server that generates the HTML pages and contains the content. While the Kodak solution is reasonable for someone to build imaging support into one Web site, the structure is highly intrusive and requires a tight integration between the Application Server, the HTML pages, and the imaging code and is not scalable across many Application Servers.

For this scenario, the development path includes creation of a series of CGI commands that execute the various operations that are performed by the Application Server (i.e. imaging processing code). Based on the user's input, the appropriate operation is executed on the content data, which will then result in generating a new HTML page that is displayed on the client. The invention described in this white paper provides a scalable solution in a fully distributed environment with little impact to the specific Application Server.

MapQuest

MapQuest provides a service such that custom map pages can be easily inserted into Web pages. This falls into the category of a server-side application. It is also possible for the MapQuest component to provide navigational controls that permit the end user (on a client computing device through his browser) to navigate the map (zoom and pan around the map).

MapQuest provides a solution that allows the owners of application servers to insert either static map pages or dynamic map pages (map images that can be zoomed or panned), which in turn is viewed and controlled by the end-user on their client browser. While it is true that MapQuest is providing this custom UI control that is inserted into the pages served up by the Application Server, there are several differences compared to this invention.

The most important of which is the MapQuest UI control generates a map based on processing of its own private data (i.e. the actual map information), based on commands from the client browser (select a city, select a road, zoom in, pan to the left, etc.). This is a less complex and different problem since the MapQuest UI control is processing its own private data, not any map data generated by the client browser (or even the Application Server). This is a key distinction since the present invention allows the custom UI control that is processed by the Imaging Server, to manipulate distributed image data (such as from the Application Server or even the client). The MapQuest “map” server is processing private data that resides on the same “map” server, not a separate server as in the case of this invention.

FlashPix/IIP Viewer

FlashPix is a multi-resolution imaging format that allows for a certain set of non-destructive edit operations (and viewing transforms) to be performed and saved with the image. The Internet Imaging Protocol (IIP) is a mechanism that takes advantage of the characteristics of the FlashPix file to provide for optimized viewing on the client. For instance, a user can quickly zoom in and pan a photo for display on the client browser.

To serve up FlashPix files from a customer/Web server, server-side application support is required to handle protocol requests from the client. On the client side, requests are made, in the form of IIP commands back to the customer/Web server, in which case the server generates the necessary images/pages. In general, the client browsers need some type of user-interface control that displays portions of the image (most likely JPEG) and has controls associated with the image (analogous to the image processing toolbar) that allow the user to zoom in/out and pan left/right the photo. These commands (zoom and pan) are relayed to the customer/Web server application via IIP commands that in turn generates the appropriate portion of the image to display back to the client. The client is responsible for rendering of these images.

What this requires is custom server side FlashPix/IIP support (not built into today's Web servers) and possibly custom client code that resides on the client computing device in the form of a plug-in, Java applet, ActiveX control, or other client side application. Any changes to the FlashPix/IIP standard, or bug fixes or additions to either side may require subsequent downloading of new code to the client or updating of the application customer/Web server components. Further, any structural changes to the IIP server components might results in additional changes to the Web page on the customer/Web server. Clearly, this does not provide the flexibility or the customizations that this invention seeks to achieve. While it is possible to create a image processing toolbar that appears like the image processing toolbar of the present invention, the internal functionality and its inherent flexibility cannot be expressed with the above technology as described. Again, the key benefit of this invention is that it requires no additional server side code to be installed on the customer/Web server.

This invention was created as a direct result of developing an imaging architecture that easily enables photo editing, manipulation, sharing, and management capabilities into a significant number photo oriented Web sites (such as photo communities, photo processing sites, etc.). The goal was to create a system that allows for minimal requirements on the photo Web site, beyond a few lines of HTML and optionally JavaScript, such that the generation of the UI controls (associated with the imaging commands) and all image processing occurs on a separate server, independent of the Application Server that hosts the photo oriented Web site. Further, in the preferred embodiment, it does not require any additional client side executable code.

This architecture allows for rapid deployment, the ability to customize different image processing toolbars and imaging capabilities of different clients (photo oriented Web sites), and the ability to add or change functionality provided to any one site independently of all others and with no changes to the Application Server. Further, this allows for a platform neutral solution that runs anywhere and does not require additional processing capabilities on the client computing device.

The user interface design makes use of a image processing toolbar that consists of a collection of tools, content, and browsing capabilities such that the user can click on an action or content, immediately see the image update based on the action, continue editing, or go back to a previous step (undo) quickly. See section 3.4 for a screen capture of the image processing toolbar.

### SUMMARY

In a client/server networked environment the present invention discloses a method and system of giving the viewer of Internet content the controls necessary to change or manipulate the Internet content. The Internet content being viewed is generated by a remote imaging server and is changed on that server and re-rendered on the viewer's device in response to the commands given by the viewer using the controls offered by the remote imaging server. Using frames, where the Web content can be divided into two or more areas and different Web servers can provide different content to those two areas, one server can be an application server and the other server can be a content manipulation server. In particular, the application server can serve up the initial content to the user, such as an image stored on the application server. If the user desires to manipulate the image, the second server can retrieve the image data from the first server and present that image along with a toolbar of manipulation tools to the user. The image and the toolbar now reside in the second frame with the original application server data still residing in the first frame. The user can then manipulate the content while viewing the content changing as a result of the manipulation. When the user is done it is then possible to save the manipulated content on the Application Server.

### BRIEF DESCRIPTION OF THE DRAWINGS

FIG. 1 shows the architecture of the system using client rendered scripting language.

FIG. 2 shows the same architecture without using a client rendered scripting language.

FIG. 3 shows an image and a toolbar displayed in a second frame on a Web page.

### DETAILED DESCRIPTION

The Imaging Server that is responsible for virtually all aspects of this system and what makes the integration of this functionality into the Application Server of the photo oriented Web site completely seamless contains two components, an Image Rendering System (IRS) and a User Interface Builder (UIB).

The IRS provides capabilities to processes commands received from the client Web browser to composite multiple images together along with vector-based artwork and high-resolution font/text data and returns the composite image to the client. The IRS also supports a wide variety of image processing and image filter capabilities. The IRS is a non-destructive, resolution-independent imaging system that preserves the user's original digital negative.

The User Interface Builder (UIB) creates the physical UI controls from a sequence of HTML commands or optionally JavaScript commands if the client supports JavaScript. The Web page returned by the Application Server can test the client's ability to support a scripting language such as JavaScript or VBScript. The responsibility of the UIB is to generate the image processing toolbar that is rendered by the client.

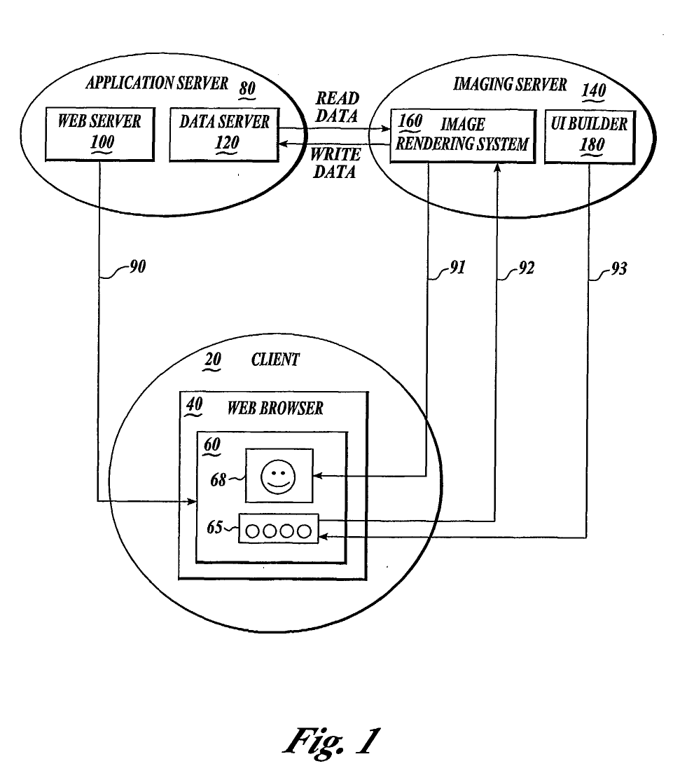

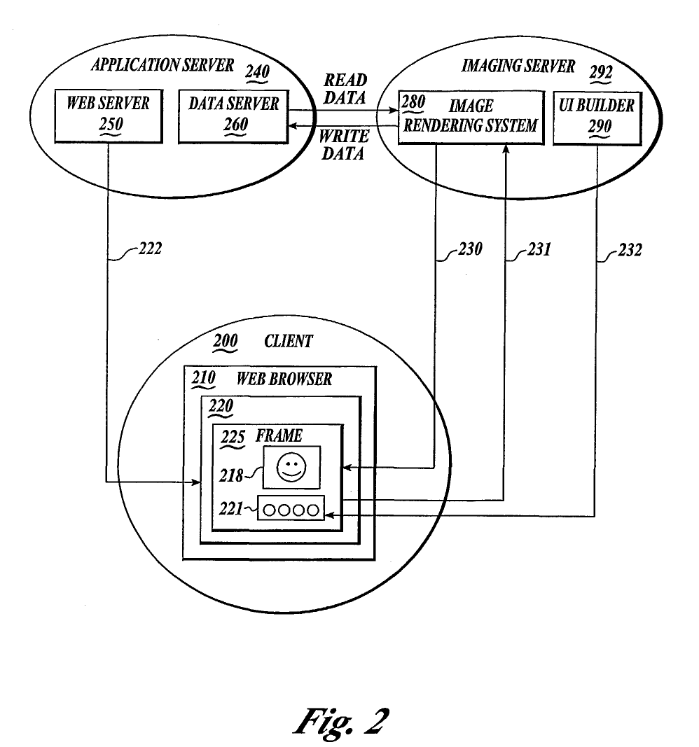

FIG. 1 and FIG. 2 show system diagrams for two embodiments of this invention. The first utilizes JavaScript capabilities of the client, if they exist.

The second utilizes image maps and frames to achieve the same results, if JavaScript is not available.

Image Processing Toolbar (using JavaScript).

The following description is how the image processing toolbar 65 is rendered and interacts with the Imaging Server 292.

The following example utilizes JavaScript to provide this functionality. The use of JavaScript is the best mode for carrying out the invention. It is expected that the use of JavaScript will be more typical due to its acceptance, and thus a detailed example is described below. However, this invention does not require JavaScript and a complete implementation can be based on image maps, independent of JavaScript. While this may not be as efficient as the presented JavaScript embodiment, this version could be employed to implement this invention if a particular client does not support JavaScript.

First, the user 20 requests that a page 60 be downloaded from the Application Server 80 (an example would be a photo oriented Web site). If this page 60, determined by the Web site creator, is to contain the image processing toolbar 65, it then contains several lines of JavaScript that are embedded inside the HTML code 90 sent to the client. This interaction is between the client-computing device 20 and the Imaging Server 140 is independent of the Application Server 80 of the photo oriented Web site.

Once the JavaScript, requesting the download of the toolbar 93 and the image 91, and the HTML code 90 are processed and rendered by the client computing device 60, the user is then able to interact with the image processing toolbar 65. When the user clicks on an icon in the image processing toolbar 65, the JavaScript code (already downloaded 93 to present the toolbar to the user) determines: (1) if the associated command 92 requires that the appearance of the image processing toolbar be updated or (2) if the command 92 is an image processing operation that must be executed on the Imaging Server 140.

In the preferred embodiment, the image processing toolbar 65 is updated via image replacement (from already downloaded UI image data on the client or from new requests from the UIB using JavaScript. With this approach, more complex (and less widely available) Dynamic HTML is not required. However, in another embodiment if a particular version of Dynamic HTML is detected, this invention could make use of Dynamic HTML for updating of the image processing toolbar, thus providing an even richer user experience if desired.

If the command is an image processing operation (such as Instant Fix), the IRS 160 is notified of the operation. The IRS will access the image (either high-resolution or low-resolution depending on the operation) from where the image resides (most likely the Application Server of the photo oriented site) and will process the image 68. On the client 20, the JavaScript determines which image on the client HTML page 60 displayed on the browser 40 is to be modified by inspection of the HTML image tag (<IMG> that is associated with the image processing toolbar). That information is then communicated 92 to the IRS such that it can directly reference the image (READ DATA operation in FIG. 1) and update the image 91 in the client page with a new version showing the results of the operation.

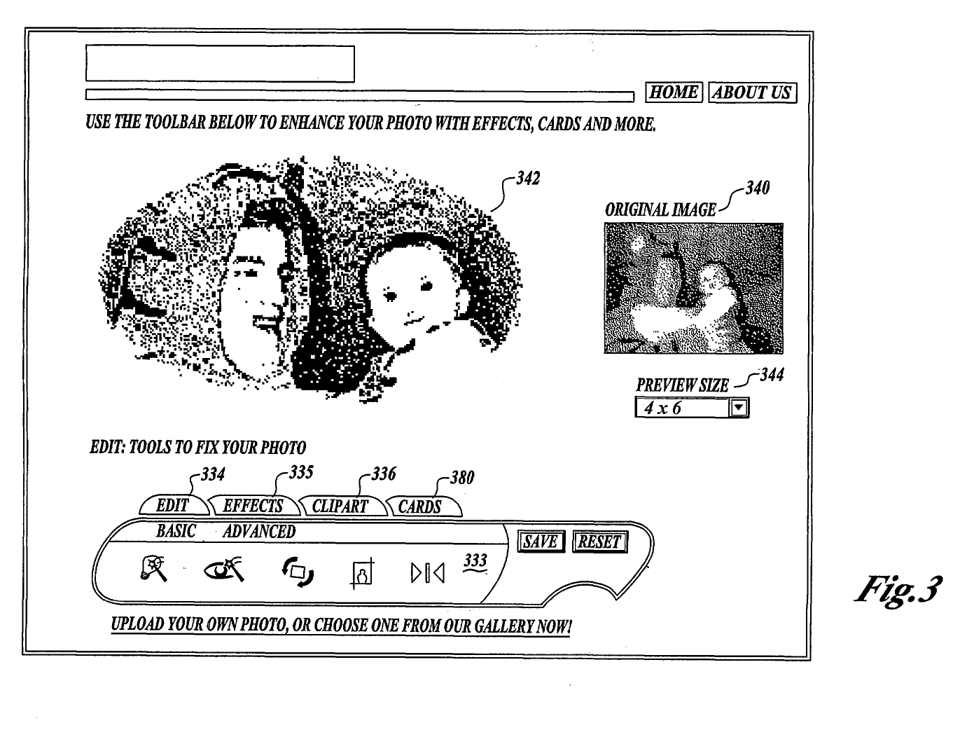

Depending on the operation, the original image source may be updated and saved on the Application Server (WRITE DATA operation in FIG. 1). Finally, the JavaScript that issued the original image processing command obtains the updated image (READ DATA) so the client can redisplay it. As an additional optimization, the image that is downloaded and displayed on the client may in fact be a sub-sampled low-resolution version 340 in FIG. 3 of the high-resolution image that was processed on the IRS, thus reducing network bandwidth requires between the client and the IRS.

The Operation of the Image Processing Toolbar (Independent of JavaScript).

The following describes how the Image processing toolbar 221 is rendered and interacts with the IRS 280, when JavaScript is not available. Again there is an application server 240, that contains a Web server 250 that delivers a Web page 220 to the client 200. This implementation is based on FIG. 2. For this embodiment, if a page 220, as determined by the Web site creator, is to contain the image processing toolbar, it will contain an HTML frame (s) 225 that displays an HTML page (s) containing the image processing toolbar 221 and the associated image 218 being manipulated. The URLs associated with the various locations within the image map will direct the Imaging Server how to update HTML page (s) containing the image processing toolbar and the associated image being manipulated.

FIG. 3; shows a representative Web page with the original image thumbnail 340, the image as modified 342, a selectable preview size 344, and four types of tools available 334, 335, 336 and 380. As the type of tool is selected then the particular tools as represented by the type of tool are displayed 333. It should be noted that the use of HTML frames is only for convenient and efficient redisplay of the HTML page on the client. A frame-less base approach could also be taken.

Other Techniques for Various Embodiments of this Invention

A number of different techniques may be used for establishing communication between the Application Server, the client, and the Image Rendering Server (IRS). One of those involves the use of “URL rewriting”. This allows a command to be embedded inside an image URL (IMG tag) that causes an image editing operation to be applied on the Image Rendering Server as a side effect of requesting the image itself. This technique allows the image in the Web page to be directly updated (rather than the entire page). This also saves a trip to the server as the command is integrated with the request for an image update.

Two approaches have been utilized for attaching the JavaScript to an HTML page on the Application Server of the photo oriented Web site. The first involves incorporation of JavaScript at the client side. With this approach, the JavaScript (or similar scripting language) is downloaded by the client where it is then executed on the client. When the client processes the script operations, JavaScript commands are accessed from the UIB and executed. This is the approach described above.

Another approach involves the use of Server Side Includes (SSI) commands. With this approach, as the Application Server encounters the location of where the image processing toolbar should appear, the Application Server invokes a URL to the imaging site. At that point, the appropriate JavaScript (or similar scripting language) and HTML code is expanded into the HTML stream that is being generated by the Application Server. The difference is that the expansion occurs on the Application Server, not the client.

Additional communication may be needed between the Application server and the Imaging Server. This invention tries to limit the necessary communication between the Application Server and the Imaging Server, thus simplifying integration of the overall system. Tighter coupling may need to be established for a variety of other reason including security. One could imagine that an Application Server may want to restrict what systems (normally only the client) that have access to the client data (such as images). In this situation, additional authentication may be needed between the Application Server and the Imaging Server. This is a separate embodiment since the general case does not require this additional communication between the Application Server and the Imaging Server.

The present invention also allows the separation of the functionality of the Client, Application Server, and the Imaging Server. In some situations, it may be desirable to physically separate the Application Server into a Web server component, whose primary function is to serve up Web pages, from the Data Server component, where data (such as still or video images) are persisted. Similarly, the Image Rendering Server can be separated into the Imaging Rendering component, utilizing very high-end processors for efficient image manipulation, and then use other servers for User Interface Building if such a physical separation is desired. Clearly, this invention does not restrict the particular architecture and provides for these and other configurations.

Modifying the Image Processing Toolbar

The authoring/building/customization of the image processing toolbar is easily performed, with only little knowledge of how the Website designer has inserted the image processing toolbar into the pages served up by the Application Server. If a particular UI control is sufficiently described (such as the size of the image processing toolbar), the author of the image processing toolbar requires no additional knowledge about how it is incorporated by the Website designer, provided it supports the supplied description (such as size). This allows the Image Rendering Server to change its appearance and modify the functionality of the image processing toolbar, without requiring changes to the Application Server or the client. For example, a new set of image filters could be easily added, additional content could be used (i.e. different cards at different times of the year), or bug fixes and other maintenance related upgrades could be performed without knowledge or changes to the Application Server or the client. This is a significant benefit of the distributed architecture since it requires no changes to either the client-computing device or the Application Server that contains the data content.

Upgrading the System

By developing a system that firmly separates the IRS from the Application Server that hosts the photos (of the photo oriented Web site) and the-client that views the Web pages, the IRS can change its functionality without affecting either the Application Server or the client.

This invention also has the flexibility to evolve its architecture to take advantage of new client browser support or new viewing and scripting capabilities as they become available on the client. This requires very little modification (if any) on the Application Server so that the user interface controls created by the Image Rendering Server can take advantage of these new architectural aspects of the client's browser. For example, if Dynamic HTML capabilities become fully standardized across all client browsers, the UI control (such as the image processing toolbar) can take advantage of these features, independent of any changes by the Application Server.

It should also be noted that if the author of the UI control wants to take advantage of advanced capabilities of one particular Web client, the Imaging Server could query the capabilities of the client browser to determine what capabilities are available and make use of such features. This can be done completely independent of the Application Server, thus providing “free” capabilities to the Application Server at no cost to them.

Use of Java/ActiveX on the client to provide richer UI experience In some embodiments, it may be desirable to utilize some client-side code (such as Java, ActiveX, etc.) for creation and display the custom UI controls (such as the image processing toolbar). However, such controls does not diminish the importance of this invention, it simply adds additional capabilities, but preserving the advantages of this architecture. As mentioned above, the Image Rendering Server could query the capabilities of the client to see if particular client-side code is supported. If not, it could resort to using standard HTML and JavaScript techniques. [In the above architecture, the UIB would be responsible for creating the Java applet that the client would then execute.]

This scenario is independent of the Application Server and is done without any changes to or knowledge of the Application Server. The few lines of JavaScript that are inserted into HTML pages on the Application Server remain unchanged; they are the same <SCRIPT> tags that reference the, Imaging Server. However, the Image Rendering Server will generate JavaScript commands that also reference a Java applet (or other client side code) that resides on the Image Rendering Server. From the point of view of the Application Server, this is transparent.

The user can interact with the UI control in much the same way he would with any UI control defined in pure HTML and JavaScript as described above. When the user issues a command from the UI control, the command is sent to the Image Rendering Server where the command is executed (such as a filter) on the data content from the Application Server. When the command is complete, the result is made available to the client such that its page can be updated directly. The use of the Java applet simply provides a richer custom UI control, but does not change the distributed nature in which the data content is processed.

Use of Java/ActiveX on the Client to Provide Real-Time Manipulation, but Retains the Benefits of the Distributed Architecture.

The use of Java or similar client side technology can also provide the ability to achieve real-time image processing effects on the client, but at a fraction of the cost if integrated via this architecture. For example, the image processing toolbar may provide for a warp imaging processing operation. It may be desirable to provide the user the ability to move around a UI control in real-time to see the dynamic effect of the warp operation on the image.

Typically, the only solution available is to download imaging processing code onto the client such that it can manipulate the image locally. While this certainly is a valid solution, it would require the downloading of the complete high-resolution image from the Application Server. While a real-time effect could be achieved, it would occur after the download of the complete high-resolution image. Once downloaded, the client side software can perform the operation. An alternative approach is to create a mechanism or protocol between the client and the Application Server to only download the resolution of the image that is needed, hopefully, a low resolution. This solution is much more desirable since it results is less network bandwidth as well as less computation complexity since the image processing operation is occurring on less pixels. However, even with this approach, it requires tight integration with the client and the Application Server.

By utilizing the present invention, the ability to incorporate this type of functionality into an Application Server is simplified, without needing to provide additional changes to the Application Server. Using the mechanism described above, the Java or ActiveX client side code can request from the IRS low-resolution data that it will process. This is possible since the IRS has access to image data content that resides on the Application Server, most likely connected through a high-speed network link. The IRS can quickly down sample the image and pass it to the client side application for processing. In parallel, the IRS can perform the same operation on the high-resolution image data, if needed, such that the updated results can be stored on the Application Server (of the photo oriented site).

parallel, the IRS can perform the same operation on the high-resolution image data, if needed, such that the updated results can be stored on the Application Server (of the photo oriented site).

Sample HTML Code and Output

The following code is a very simple example of how a image processing toolbar can be incorporated into a Web page. See the comments in the file for a description of each statement.

HTML Sample
<HTML>

<HEAD>

<TITLE>Toolbar Test</TITLE>
<!—The following two <SCRIPT> tags must
be included in the <HEAD>

tag of any page that is to . -->

<!—include the Toolbar. The first <SCRIPT>
references the script

defining
the JavaScript classes that will. -->

<!—be used throughout this file. The second <SCRIPT>
tag references

the script that instantiates a toolbar -->

<!—with properties unique to a particular
Application Server. Both of these

tags are required. The first one will normally. -->

<!— be common across all Application Servers.
The second one will most

likely be different across. -->

<!— various Application Servers since it is each
may have its own particular

appearance. -->

<!-- Toolbar classes: must be in HEAD -->
<SCRIPT LANGUAGE=“JavaScript”

SRC=“http://www.pictureiq.com/client/toolbar.js”>

</SCRIPT>
<!-- Customer-specific Toolbar instance:
must be in HEAD -->
<SCRIPT LANGUAGE=“JavaScript”

SRC=“http://www.pictureiq.com/client/zing/
toolbar-instance.js”>

</SCRIPT>

</HEAD>

<!—Arrange the before and after photo into an
HTML table. This structure

is independent of how the -->

<!—JavaScript accesses the image reference. -->

<BODY>

<H1 align=center>Toolbar Test</H1>
<TABLE BORDER=0 CELLSPACING=0 CELLPADDING=0>

<TR align=center>

<TD>

<!-- Display last saved image. Must have
NAME=“saved-image -->
<IMG SRC=“ ” width=160
height=120 border=0 hspace=10

vspace=0 NAME=“saved-image”><BR>

Saved Image</TD>

<TD>

<!-- Display image being
manipulated. Must have NAME=

“work-image -->

<IMG SRC=“ ” width=320
height=240 border=0 hspace=10

vspace=0 NAME=“work-image”></TD>

</TR>
<TR align=center>

<TD></TD>
<TD>

<!—This provides for
customer-specific HTML generation for a

specific Toolbar layout. -->

<!—This tag can appear anywhere
in the <BODY> section. -->
<SCRIPT LANGUAGE=“JavaScript”

SRC=“http://www.pictureiq.com/layout/client/
zing/toolbar-layout.html”>

</SCRIPT></TD>

</TR>

</TABLE>
<HR>
<FONT size=2>&copy; 2000 PictureIQ
Corporation.&nbsp;&nbsp;All rights

reserved.&nbsp;&nbsp;&nbsp;&nbsp;</FONT>

<!—This sets up the Toolbar communication
between the servers and

display the Toolbar. -->

<!—This is always last element in <BODY>-->
<SCRIPT LANGUAGE=“JavaScript”>

<!-- URL of server where Toolbar
retrieves its assets

(icons and artwork): usually a PictureIQ Imaging Server -->

toolbar.setAssetServerURL(“http://www.pictureiq.com”);
<!-- URL of server where image editing
operations performed: always

a PictureIQ Imaging Server -->

toolbar.setManipServerURL
(“http://www.pictureiq.com/photo”);
<!-- URL of original image to manipulate:
The Application Server (more

specifically the Data Server)-->

toolbar.setOriginalImageURL
(“http://www.zing.com/blake/

Pic00005.jpg”);

<!-- URL to save a modified image to:
The Application Server (more

specifically the Data Server)-->

toolbar.setSaveImageURL
(“http://www.zing.com/save/

blake/save/Pic00005.jpg”);

<!—Optionally preload the Toolbar art assets -->
toolbar.preload( );
<!-- Display the first tab of tools -->
toolbar.selectTab(0);

</SCRIPT>

While there have been shown and described several embodiments of the present invention, it will be obvious to those skilled in the art that various changes and modifications may be made therein without departing from the scope of the invention as defined by the appending claims.

We claim:

1) In a networked environment, a method for embedding one or more user interface controls inside Internet content, said method comprising:
a) a first server sending, upon a user agent request, a first frame of Internet content and a second frame of Internet content; and
b) said second frame of Internet content is generated by a second server and comprises controls capable of transforming said second frame of Internet content.

2) The method of claim 1 wherein the first server is an application server and the second server is an image rendering server.

3) The method of claim 1 wherein the control capable of transforming said second frame of Internet content is represented by a control icon.

4) The method of claim 1 wherein the second frame of Internet content comprises a digital image and the control icon.

5) The method of claim 1 wherein the user agent is a Web browser.

6) The method of claim 4 wherein the digital image is retrieved by the second server from the first server and is presented in the second frame by the second server along with said control icons generated by the second server.

7) The method of claim 3 wherein a set of control icons represent an image transformation toolbar.

8) The method of claim 7 wherein multiple toolbars may be selected by the user.

9) A system for embedding one or more user interface controls inside Internet content, said system comprising:
a) a first server that sends, upon a user agent request, a first frame of Internet content and a second frame of Internet content; and
b) a second server that generates said second frame of Internet content that comprises controls capable of transforming said second frame of Internet content.

10) The system of claim 9 wherein the first server is an application server and the second server is an image rendering server.

11) The system of claim 9 wherein the control capable of transforming said second frame of Internet content is represented by a control icon.

12) The system of claim 9 wherein the second frame of Internet content comprises a digital image and the control icon.

13) The system of claim 9 wherein the user agent is a Web browser.

14) The system of claim 12 wherein the digital image is retrieved by the second server from the first server and is presented in the second frame by the second server along with said control icons generated by the second server.

15) The system of claim 11 wherein a set of control icons represent an image transformation toolbar.

16) The system of claim 15 wherein a set of multiple toolbars may be selected by the user.
